(19) United States
(12) Patent Application Publication
(10) Pub. No.: US 2020/0384487 A1
(43) Pub. Date: Dec. 10, 2020

(54) Shower Head Assembly

(71) Applicant: YO CA CASTERS CO., LTD., Taichung (TW)

(72) Inventor: Chin-Lin CHANG, Taichung (TW)

(21) Appl. No.: 16/433,815

(22) Filed: Jun. 6, 2019

(51) Int. Cl. B05B 3/04; B05B 1/18

(52) U.S. Cl. CPC B05B 3/04; B05B 1/18

(57) ABSTRACT

A shower head assembly contains: a body, a fixing platform, a cover, a holding zone, and a fixing unit. The body includes a shower head and a grip portion, the shower head has a receiving chamber, and the grip portion has a channel. The grip portion has an accommodation slot. The cover includes multiple nozzles communicating with the receiving chamber. The holding zone is defined on the cover and has multiple through orifices. The fixing unit includes a movable massage set and a controller. The movable massage set corresponds to the holding zone of the cover and the fixing platform, and the movable massage set includes multiple positioning stems inserting through multiple apertures respectively. Bottoms of the multiple positioning stems are connected on a rotary holder, and the controller further includes an operation tab accommodated in the accommodation slot of the grip portion of the body.

### FIELD OF THE INVENTION

The present invention relates to a shower head assembly which accommodates a movable massage set conveniently and safely.

### BACKGROUND OF THE INVENTION

A conventional shower head assembly contains a message set extending therefrom, but the message set is broken easily when the conventional shower head assembly drops on a floor.

The present invention has arisen to mitigate and/or obviate the afore-described disadvantages.

### SUMMARY OF THE INVENTION

The primary objective of the present invention is to provide a shower head assembly which contains the movable massage set configured to massage and wash a user, when the movable massage set extends out of the holding zone.

Another objective of the present invention is to provide a shower head assembly which contains the movable massage set configured to retract into the shower head, when the movable massage set removes from the holding zone.

To obtain above-mentioned objective, a shower head assembly provided by the present invention contains: a body, a fixing platform, a cover, a holding zone, and a fixing unit.

The body includes a shower head and a grip portion, the shower head has a receiving chamber defined in the shower head, and the grip portion has a channel communicating with the receiving chamber.

The fixing platform is arranged in the receiving chamber, and the grip portion has an accommodation slot communicating with the fixing platform.

The cover covers the body and the receiving chamber, and the cover includes multiple nozzles arranged on the cover and communicating with the receiving chamber.

The holding zone is defined on the cover and is separated from the multiple nozzles, and the holding zone has multiple through orifices.

The fixing unit includes a movable massage set and a controller.

The movable massage set corresponds to the holding zone of the cover and the fixing platform, and the movable massage set includes multiple positioning stems inserting through multiple apertures of the holding zone respectively, wherein bottoms of the multiple positioning stems are connected on a rotary holder, and the controller further includes an operation tab accommodated in the accommodation slot of the grip portion of the body.

### BRIEF DESCRIPTION OF THE DRAWINGS

FIG. 1 is a perspective view showing the operation of a shower head assembly according to a preferred embedment of the present invention.

FIG. 2 is another perspective view showing the operation of the shower head assembly according to the preferred embedment of the present invention.

FIG. 3 is a perspective view showing the exploded components of the shower head assembly according to the preferred embedment of the present invention.

FIG. 4 is a perspective view showing the exploded components of the shower head assembly according to the preferred embedment of the present invention.

FIG. 5 is a side plan view showing the operation of the shower head assembly according to the preferred embedment of the present invention.

FIG. 6 is another side plan view showing the operation of the shower head assembly according to the preferred embedment of the present invention.

FIG. 7 is also another side plan view showing the operation of the shower head assembly according to the preferred embedment of the present invention.

FIG. 8 is still another side plan view showing the operation of the shower head assembly according to the preferred embedment of the present invention.

FIG. 9 is a side plan view showing the operation of the shower head assembly according to another preferred embedment of the present invention.

FIG. 10 is a perspective view showing the operation of the shower head assembly according to another preferred embedment of the present invention.

FIG. 11 is a perspective view showing the operation of the shower head assembly according to another preferred embedment of the present invention.

### DETAILED DESCRIPTION OF THE PREFERRED EMBODIMENTS

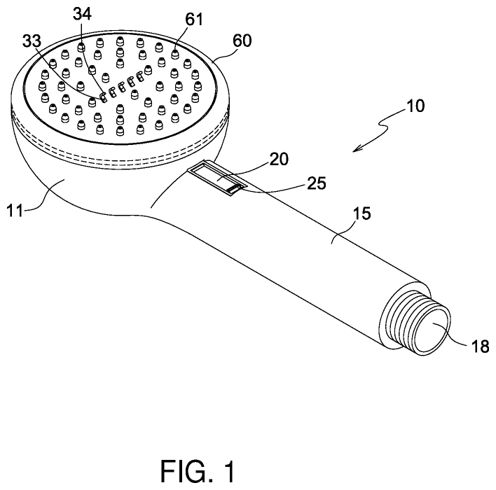

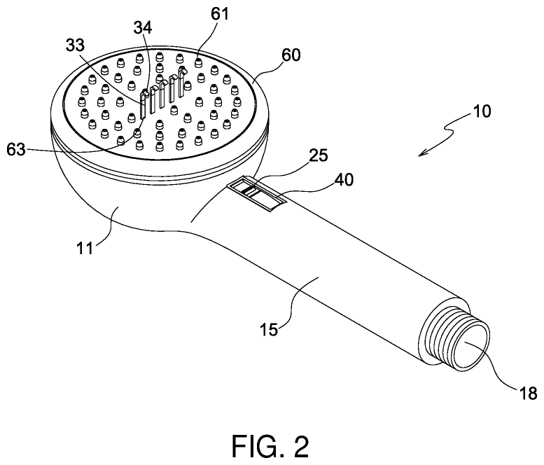

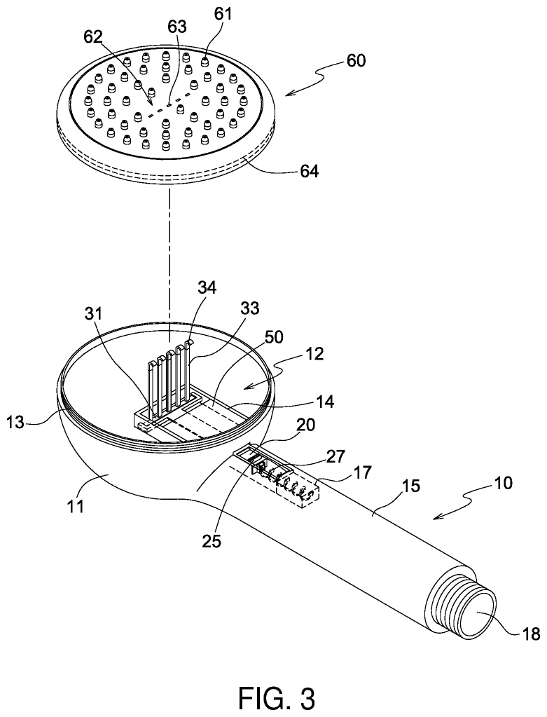

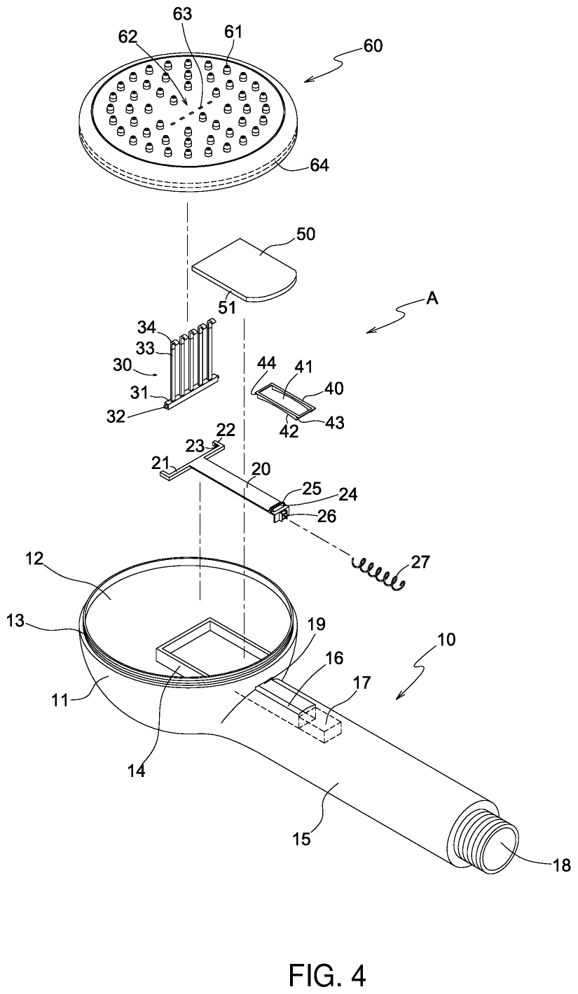

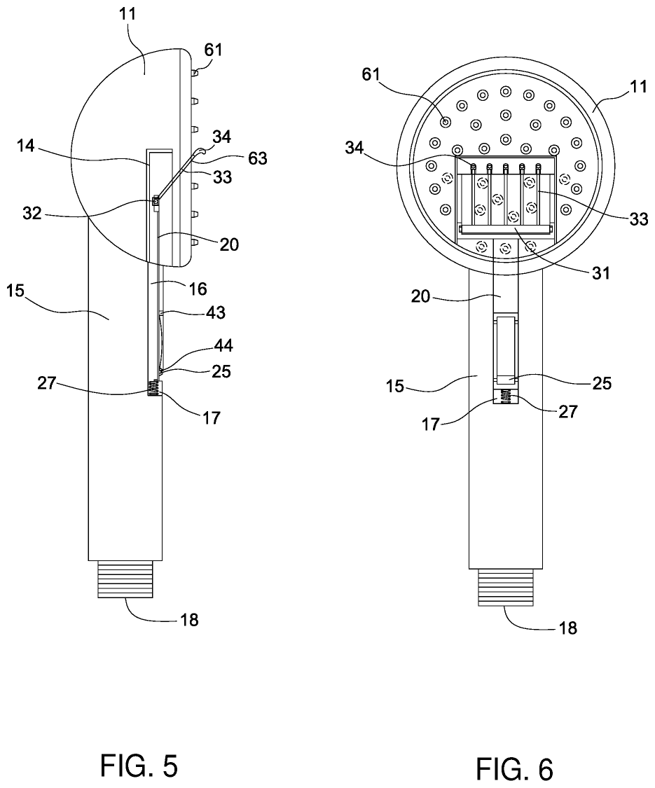

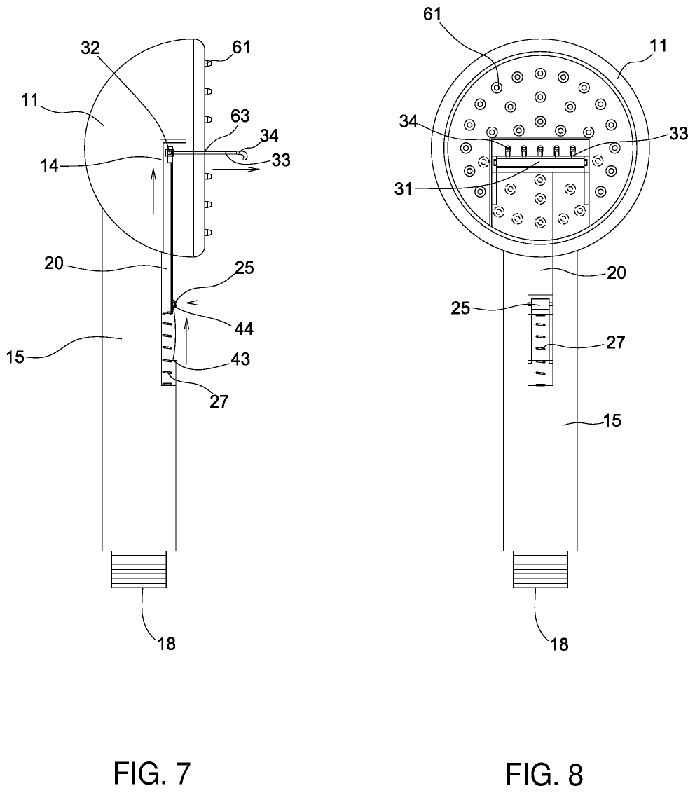

With reference to FIGS. 1-8, a shower head assembly according to a preferred embodiment of the present invention comprises:

a body 10 including a shower head 11 and a grip portion 15, the shower head 11 having a receiving chamber 12 defined in the shower head 11, the grip portion 15 having a channel 18 communicating with the receiving chamber 12 so that water flows into the receiving chamber 12 via the channel 18; wherein the shower head 11 further has an external threaded section 13 formed around an outer wall thereof;

a fixing platform 14 arranged in the receiving chamber 12 and partially covered by a lid 50 with a connection fringe 51, wherein the connection fringe 51 of the lid 50 is adhered with an inner wall of the fixing platform 14 by ways of adhesive, and the grip portion 15 has an accommodation slot 16 communicating with the fixing platform 14, wherein a communication portion 19 is defined between the receiving chamber 12 and the accommodation slot 16;

a cover 60 covering the receiving chamber 12 and including an internal threaded section 64 formed on an inner wall of the cover 60 so as to screw with the external threaded section 13 of the body 10, and the cover 60 including multiple nozzles 61 arranged on the cover 60 and communicating with the receiving chamber 12 so that the water sprays out of the multiple nozzles 61;

a holding zone 62 defined on the cover 60 and separating from the multiple nozzles 61, and the holding zone 62 having multiple through orifices 63;

a fixing unit A including a movable massage set 30 and a controller 20; wherein

the movable massage set 30 corresponds to the holding zone 62 of the cover 60 and the fixing platform 14, and the movable massage set 30 includes multiple positioning stems 33 inserting through multiple apertures 63 of the holding zone 62 respectively, the multiple positioning stems 33 have multiple hooks 34 extending from free ends of the multiple positioning stems 33 individually so that the multiple positioning stems 33 insert through multiple apertures 63 respectively, and the multiple hooks 34 are connected with free ends of the multiple positioning stems 33 individually in an adhering manner, wherein the multiple hooks 34 are made of flexible plastic material; bottoms of the multiple positioning stems 33 are connected on a rotary holder 31, and the rotary holder 31 has two rotatable joining segments 32 extending from two ends thereof respectively;

the controller 20 is arranged to correspond to the fixing platform 14, the communication portion 19, and the accommodation slot 16 of the body 10, wherein the controller 20 includes a locating portion 21 rotatably connected with the rotary holder 31 of the movable massage set 30, the locating portion 21 has two peripheral pegs 22 extending from two ends thereof respectively, and the two peripheral pegs 22 have two notches 23 defined therein individually, wherein the two notches 23 are rotatably connected with the two rotatable joining segments 32 of the movable massage set 30 individually so that the two rotatable joining segments 32 of the movable massage set 30 rotate relative to the two notches 23 of the controller 20 respectively;

wherein the controller 20 further includes an operation tab 25 accommodated in the accommodation slot 16 of the grip portion 15 of the body 10 so as to be pushed by a user, the operation tab 25 of the controller 20 has two extensions 24 extending from two sides of the operation tab 25 respectively, the accommodation slot 16 of the body 10 has a limitation rib 40 extending therefrom relative to the controller 20 and connected with the accommodation slot 16 in an adhering manner, wherein a hollow space 41 is defined by the limitation rib 40, and the limitation rib 40 has two concaved arcuate ribs 42 extending therefrom and corresponding to the two extensions 24 individually, wherein the two concaved arcuate ribs 42 have two first defining segments 44 and two second defining segments 43 respectively and configured to control the two extensions 24 of the operation tab 25 to slide forward and backward, for example, when the operation tab 25 is positioned on one of the two first defining segments 44, the movable massage set 30 extends; when the operation tab 25 is positioned on one of the two second defining segments 43, the movable massage set 30 retracts.

The controller 20 includes a flexible locking portion 26 formed on a distal end thereof and configured to abut against a resilient element 27, and the accommodation slot 16 of the body 10 has a groove 17 extending from a rear end of the accommodation slot 16 of the body 10 and configured to receive the resilient element 27, wherein when the operation tab 25 is located on the two second defining segments 43, the movable massage set 30 is retracted, and the resilient element 27 is pressed. After pressing the operation tab 25, the two extensions 24 of the operation tab 25 remove from the two second defining segments 43 respectively, and the resilient element 27 returns and pushes the controller 20 to move forward, hence the operation tab 25 is located on the one first defining segment 44, and the movable massage set 30 extends outward. Thereby, the operation tab 25 is slid to drive the controller 20 by which the movable massage set 30 is actuated to remove from or to extend out of the holding zone 62 of the cover 60. When the movable massage set 30 extends out of the holding zone 62, it messages and washes the user. When the movable massage set 30 removes from the holding zone 62, it retracts into the shower head 11.

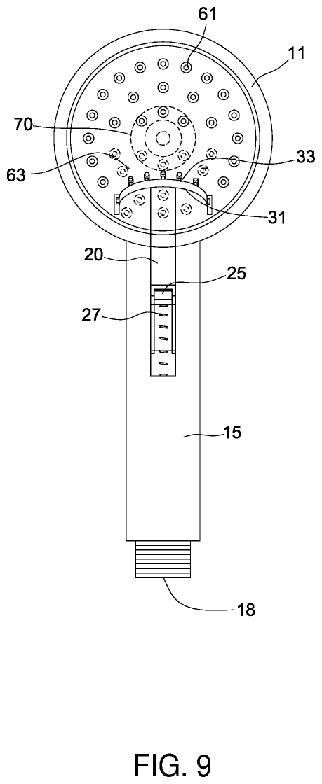

Referring to FIG. 9, in another embodiment, the body 10 includes a shaft element 70 arranged on a center thereof and formed in a convex arc shape, wherein the movable massage set 30 and the rotary holder 31 are formed in a concave arc shape so as to correspond to the shaft element 70.

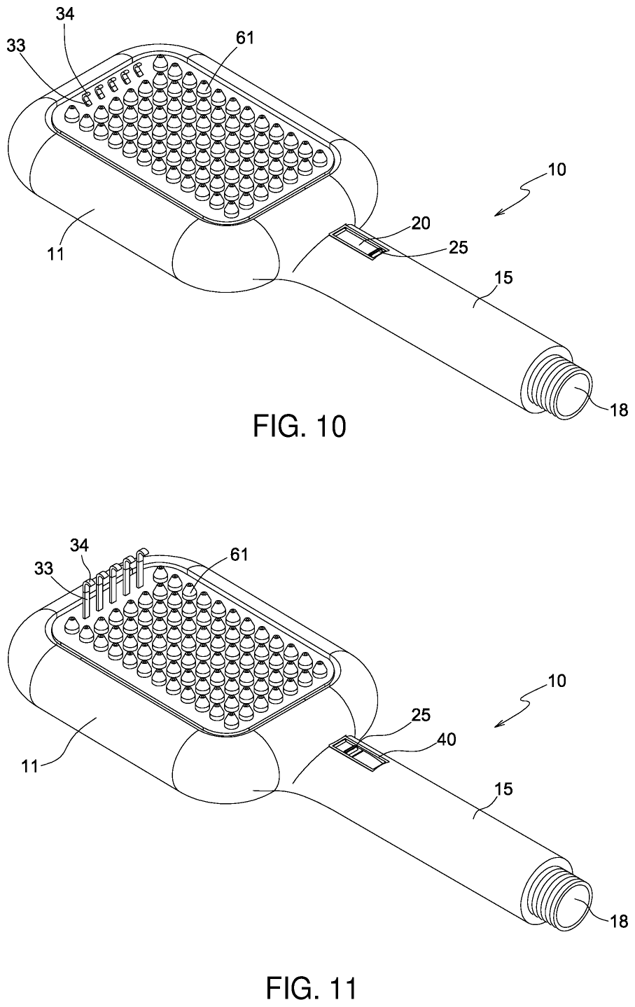

Referring to FIGS. 10-11, in another embodiment, the shower head 11 of the body 10 is in a rectangle shape so that free ends of the multiple positioning stems 33 are formed on a top of the shower head 11.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A shower head assembly comprising:
a body including a shower head and a grip portion, the shower head having a receiving chamber defined in the shower head, the grip portion having a channel communicating with the receiving chamber;
a fixing platform arranged in the receiving chamber, and the grip portion having an accommodation slot communicating with the fixing platform;
a cover covering the body and the receiving chamber, and the cover including multiple nozzles arranged on the cover and communicating with the receiving chamber;
a holding zone defined on the cover and separating from the multiple nozzles, and the holding zone having multiple through orifices;
a fixing unit including a movable massage set and a controller; wherein
the movable massage set corresponds to the holding zone of the cover and the fixing platform, and the movable massage set includes multiple positioning stems inserting through multiple apertures of the holding zone respectively, wherein bottoms of the multiple positioning stems are connected on a rotary holder, and the controller further includes an operation tab accommodated in the accommodation slot of the grip portion of the body.

2. The shower head assembly as claimed in claim 1, wherein the shower head of the body further has an external threaded section formed around an outer wall thereof, and the cover includes an internal threaded section formed on an inner wall of the cover so as to screw with the external threaded section of the body.

3. The shower head assembly as claimed in claim 1, wherein the locating portion of the controller has two peripheral pegs extending from two ends thereof respectively, the two peripheral pegs have two notches defined therein individually, and the rotary holder has two rotatable joining segments extending from two ends thereof respectively, wherein the two notches are rotatably connected with the two rotatable joining segments of the movable massage set individually.

4. The shower head assembly as claimed in claim 1, wherein the multiple positioning stems have multiple hooks extending from free ends of the multiple positioning stems individually.

5. The shower head assembly as claimed in claim 4, wherein the multiple positioning stems insert through multiple apertures respectively, and the multiple hooks are connected with free ends of the multiple positioning stems individually in an adhering manner.

6. The shower head assembly as claimed in claim 1, wherein the controller includes a flexible locking portion formed on a distal end thereof and configured to abut against a resilient element, and the accommodation slot of the body has a groove extending from a rear end of the accommodation slot of the body and configured to receive the resilient element.

7. The shower head assembly as claimed in claim 1, wherein the operation tab of the controller has two extensions extending from two sides of the operation tab respectively, the accommodation slot of the body has a limitation rib extending therefrom relative to the controller, and the limitation rib has two concaved arcuate ribs extending therefrom and corresponding to the two extensions individually, wherein the two concaved arcuate ribs have two first defining segments and two second defining segments respectively and configured to control the two extensions of the operation tab to slide forward and backward.

8. The shower head assembly as claimed in claim 1, wherein a fixing platform is partially covered by a lid with a connection fringe, and the connection fringe of the lid is adhered with an inner wall of the fixing platform by ways of adhesive.

9. The shower head assembly as claimed in claim 1, wherein a communication portion is defined between the receiving chamber and the accommodation slot.

10. The shower head assembly as claimed in claim 1, wherein the body includes a shaft element arranged on a center thereof and formed in a convex arc shape, wherein the movable massage set and the rotary holder are formed in a concave arc shape so as to correspond to the shaft element.
